(19) United States
(12) Patent Application Publication
(10) Pub. No.: US 2014/0333406 A1
(43) Pub. Date: Nov. 13, 2014

(54) COMMON MODE FILTER AND METHOD OF MANUFACTURING THE SAME

(71) Applicant: Samsung Electro-Mechanics Co., Ltd., Suwon-Si (KR)

(72) Inventors: Jin Hyuck YANG, Suwon-Si (KR); Kang Heon HUR, Suwon-Si (KR); Sung Kwon WI, Suwon-Si (KR); Ho Jin YUN, Suwon-Si (KR); Hye Won BANG, Suwon-Si (KR); Young Do KWEON, Suwon-Si (KR); Won Chul SIM, Suwon-Si (KR)

(73) Assignee: SAMSUNG ELECTRO-MECHANICS CO., LTD., Suwon-Si (KR)

(21) Appl. No.: 14/270,443

(22) Filed: May 6, 2014

(30) Foreign Application Priority Data
May 7, 2013 (KR) 10-2013-0051183

(51) Int. Cl. H01F 27/28; H01F 41/14; H01F 41/34

(52) U.S. Cl. CPC H01F 27/2804; H01F 41/34; H01F 41/14
USPC 336/200; 29/602.1

(57) ABSTRACT

The present invention relates to a common mode filter.

A common mode filter in accordance with the present invention includes a magnetic substrate formed of a magnetic ceramic material; a first coil pattern and a second coil pattern sequentially formed on the magnetic substrate; an external electrode laminated on the second coil pattern; a via for connecting the first coil pattern and the second coil pattern; and a second insulating layer formed between the first coil pattern and the second coil pattern, wherein the height of the second insulating layer is 5 μm to 20 μm while being proportional to the height of the via and thus it is possible to improve SRF and insertion loss characteristics by adjusting the height of the second insulating layer.

### CROSS-REFERENCE TO RELATED APPLICATIONS

Claim and incorporate by reference domestic priority application and foreign priority application as follows:

### CROSS REFERENCE TO RELATED APPLICATION

This application claims the benefit under 35 U.S.C. Section 119 of Korean Patent Application Serial No. 10-2013-0051183, entitled filed May 7, 2013, which is hereby incorporated by reference in its entirety into this application.”

### BACKGROUND OF THE INVENTION

1. Field of the Invention

The present invention relates to a common mode filter and a method of manufacturing the same, and more particularly, to a common mode filter and a method for manufacturing the same that forms a via connected to an upper coil pattern first after forming a lower coil pattern.

2. Description of the Related Art

As the speed of technological development accelerates, electronic devices such as mobile phones and digital TVs have been developed to have a high resolution and the amount of data transmitted between the devices or inside the devices increases. Thus, high speed transmission environments such as HDMI, DVI, MHL, USB 2.0, and USB 3.0 are required.

These interfaces employ a differential signal system that transmits a differential signal (differential mode signal) using a pair of signal lines, unlike a single-end transmission system that has been generally used for a long time. However, the digitalized and high speed electronic devices are sensitive to external stimuli.

That is, when a low abnormal voltage and a high frequency noise are introduced into an internal circuit of the electronic device from the outside, circuit damage or signal distortion may occur.

In order to prevent the circuit damage or the signal distortion of the electronic device, a filter is installed to prevent an abnormal voltage and a high frequency noise from being introduced into the circuit. Generally, a common mode filter is used in a high speed differential signal line to remove a common mode noise.

The common mode noise is a noise generated in the differential signal line, and the common mode filter removes noises that cannot be removed by the existing EMI filter. The common mode filter contributes to improvement of EMC characteristics of home appliances or improvement of antenna characteristics of mobile phones.

The employment of the filter for removing a common mode noise has been necessarily increased according to the high frequency signals between the devices.

In the past, when manufacturing a common mode filter, a first insulating layer is laminated on a magnetic substrate, a ferrite sheet having a first coil pattern thereon is laminated on the first insulating layer, a second insulating layer is laminated on the first coil pattern, a second coil pattern is formed on the second insulating layer, and a process of forming a via for connecting the first coil pattern and the second coil pattern is performed.

At this time, an uneven bumpy surface is formed according to the shape of a coil when spin coating a liquid type polymer insulator.

Further, when curing the polymer insulator, doming of the insulator occurs due to shrinkage of a polymer and cracks occur due to a wet process or penetration of external moisture. Thus, since the insulating layer is not formed vertically, the coil pattern may not embedded in the insulating layer or may be connected to the via to cause a short.

### RELATED ART DOCUMENT

### Patent Document

Patent Document 1: Japanese Patent Laid-open Publication No. 2009-188111

### SUMMARY OF THE INVENTION

The present invention has been invented in order to overcome the above-described problems and it is, therefore, an object of the present invention to provide a common mode filter that can adjust the thickness of an insulating layer by forming a via for connecting a first coil pattern and a second coil pattern before a second insulating layer.

In accordance with one aspect of the present invention to achieve the object, there is provided a common mode filter including: a magnetic substrate formed of a magnetic ceramic material; a first coil pattern and a second coil pattern sequentially formed on the magnetic substrate; an external electrode laminated on the second coil pattern; a via for connecting the first coil pattern and the second coil pattern; and a second insulating layer formed between the first coil pattern and the second coil pattern, wherein the height of the second insulating layer is 5 μm to 20 μm while being proportional to the height of the via.

At this time, the external electrodes may be provided in a plural number to be connected to respective ends of the first coil pattern and the second coil pattern one to one.

In accordance with another aspect of the present invention to achieve the object, there is provided a method of manufacturing a common mode filter, including the steps of: applying a first PR on a magnetic substrate having a first seed layer thereon; forming a first coil pattern by performing electroplating using the first seed layer as a lead line after selectively etching the first PR; applying a second PR on the first PR and etching the second PR to form a first opening in the first coil pattern; forming a via by filling a conductive paste in the first opening; forming a first cavity by stripping the first PR and the second PR; forming a second insulating layer by filling an insulating material in the first cavity; forming a second coil pattern on the second insulating layer; and forming an external electrode on the second coil pattern.

At this time, the step of forming the external electrode may further include the step of processing a via for mutually connecting a plurality of external electrodes corresponding to the first coil pattern and the second coil pattern one to one.

In accordance with another aspect of the present invention to achieve the object, there is provided a method of manufacturing a common mode filter, including the steps of: applying a first PR on a substrate having a first seed layer thereon; forming a first coil pattern by performing electroplating using the first seed layer as a lead line after selectively etching the first PR; applying a second PR on the first PR and etching the second PR to form a first opening in the first coil pattern; forming a via by filling a conductive paste in the first opening; forming a first cavity by stripping the first PR and the second PR; applying a third PR on a second insulating layer; forming a second coil pattern by performing electroplating using a second seed layer as a lead line after selectively etching the third PR; applying a fourth PR on the third PR and etching the fourth PR to form a second opening in the second coil pattern; forming a bump electrode by filling a conductive paste in the second opening; and forming a second cavity by stripping the third PR and the fourth PR.

At this time, the method of manufacturing a common mode filter may further include the step of laminating a first insulating layer before the step of applying the first PR.

Further, when applying the second PR, the height of the second PR may be 5 to 20 μm.

Further, the first opening may be formed in the innermost first coil pattern.

Further, the step of forming the first cavity by stripping the first PR and the second PR may further include the step of forming a first electrode coil by further including a flash etching process.

Further, the second insulating layer may be formed by applying an insulating material after the step of forming the first cavity.

Further, a third insulating layer may be formed by applying an insulating material after the step of forming the second cavity.

Further, the second opening may be formed on a second electrode coil.

Further, the step of forming the second cavity by stripping the third PR and the fourth PR may further include the step of forming the second electrode coil by further including a flash etching process.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a perspective view of a common mode filter in accordance with an embodiment of the present invention;

FIG. 2 is a cross-sectional view taken along line I-I′ of FIG. 1;

FIGS. 3A-3L are a process flowchart sequentially showing a method of manufacturing a common mode filter in accordance with the present invention; and

FIGS. 4A-4B and 5A-5B are graphs showing common mode impedance, SRF, and cutoff frequency characteristics according to the height of a second insulating layer.

### DETAILED DESCRIPTION OF THE PREFERABLE EMBODIMENTS

Advantages and features of the present invention and methods of accomplishing the same will be apparent by referring to embodiments described below in detail in connection with the accompanying drawings. However, the present invention is not limited to the embodiments disclosed below and may be implemented in various different forms. The exemplary embodiments are provided only for completing the disclosure of the present invention and for fully representing the scope of the present invention to those skilled in the art.

Terms used herein are provided to explain embodiments, not limiting the present invention. Throughout this specification, the singular form includes the plural form unless the context clearly indicates otherwise. When terms “comprises” and/or “comprising” used herein do not preclude existence and addition of another component, step, operation and/or device, in addition to the above-mentioned component, step, operation and/or device.

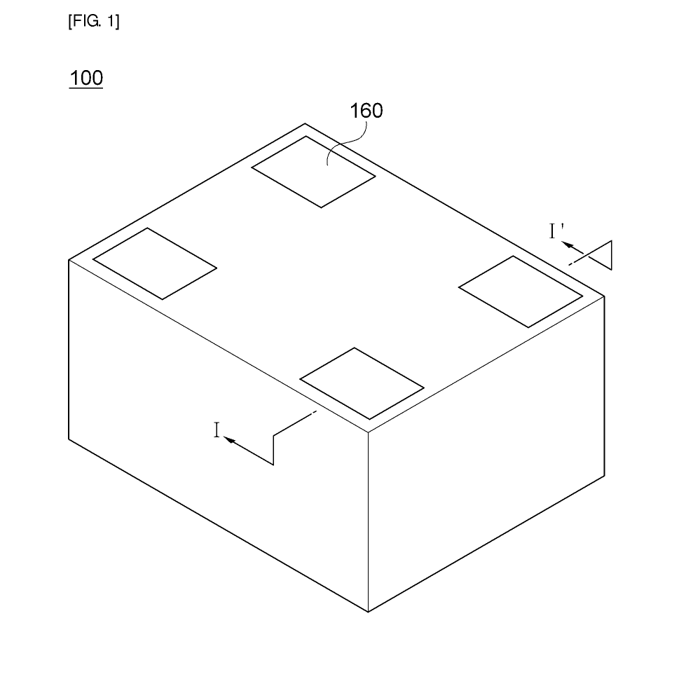

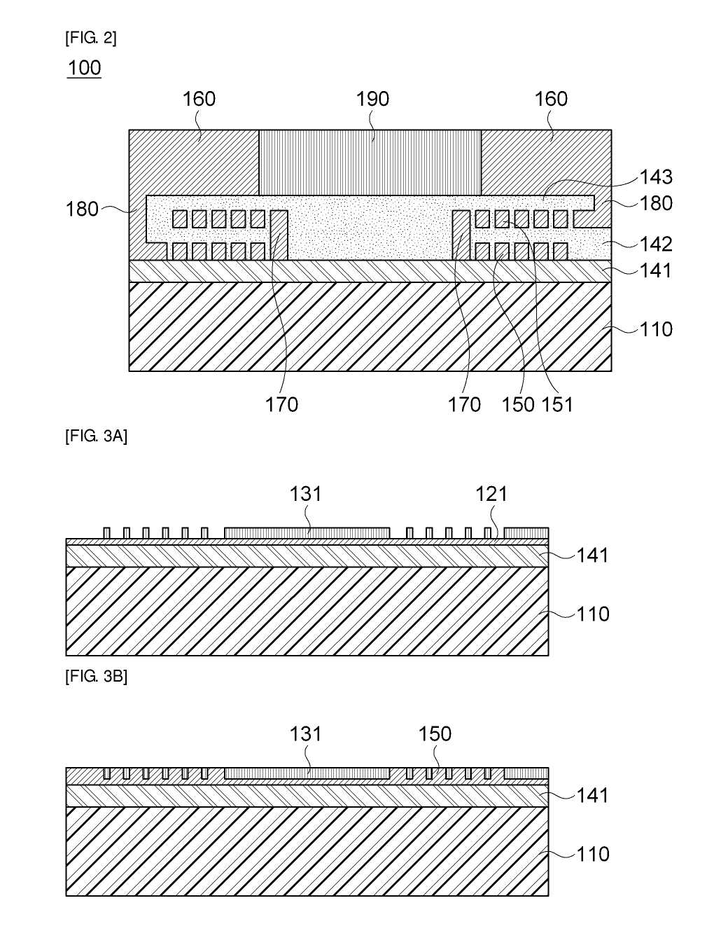

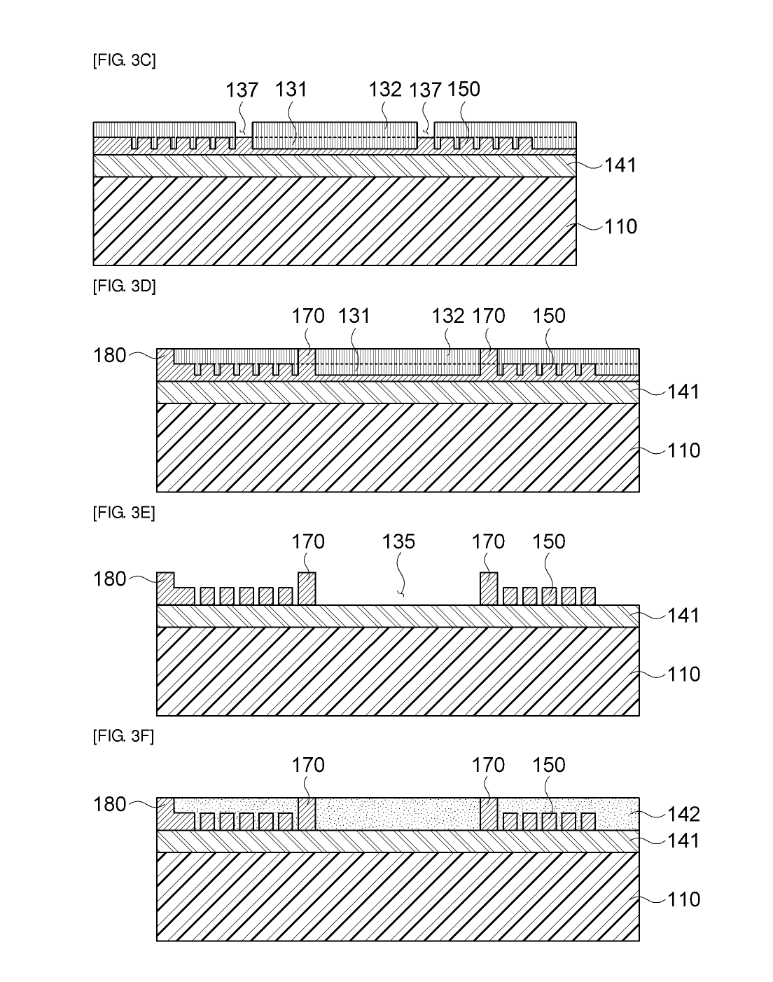

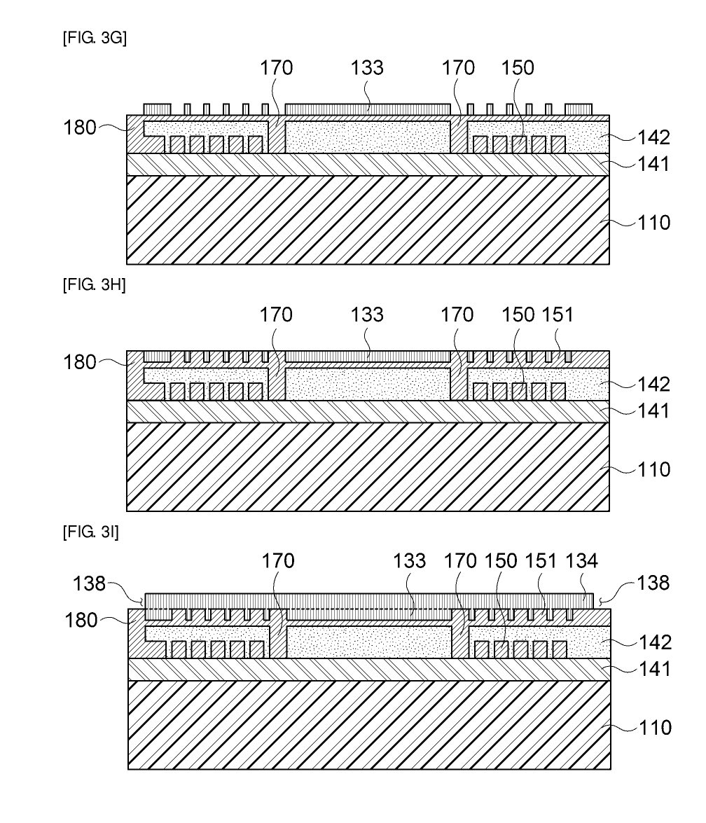

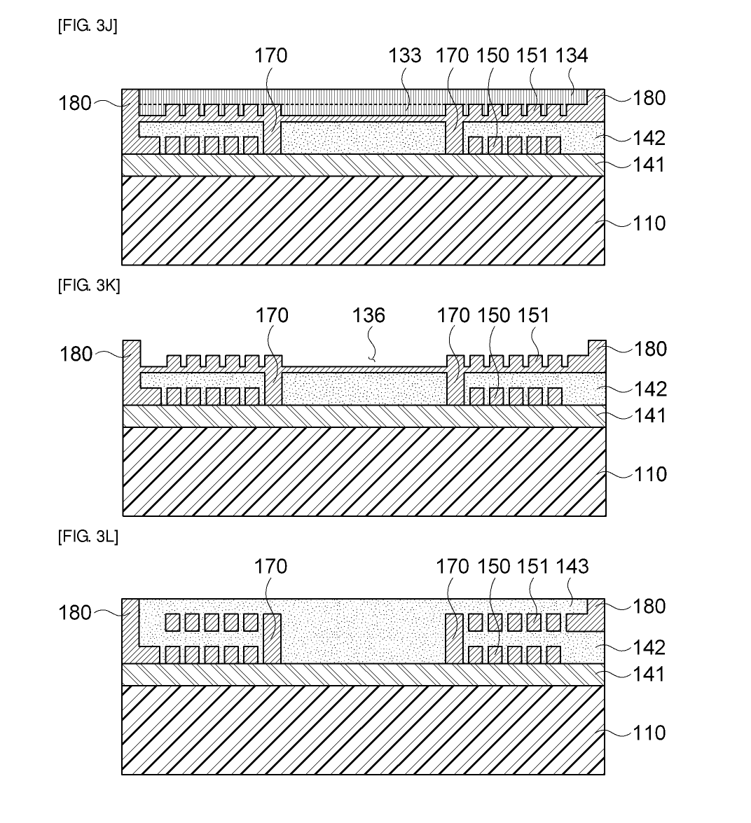

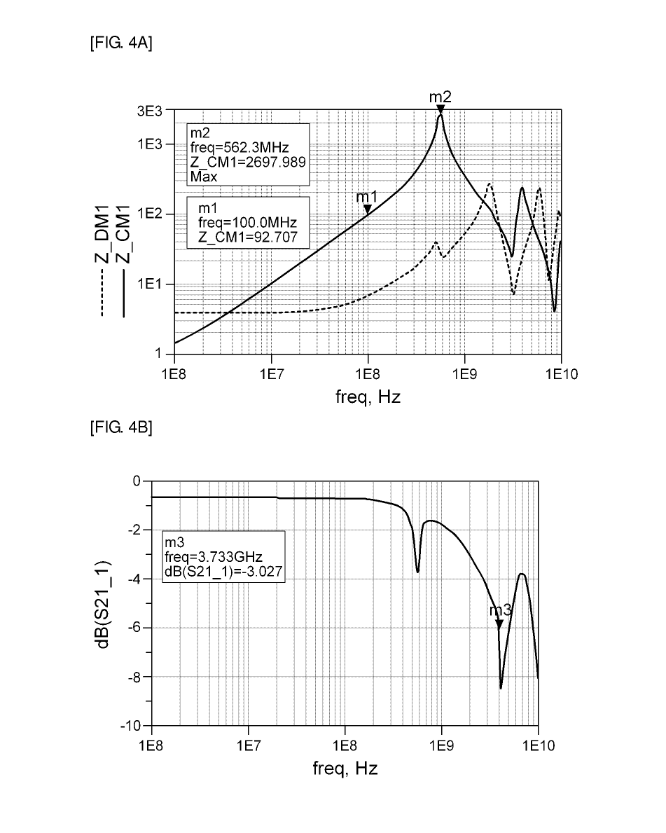

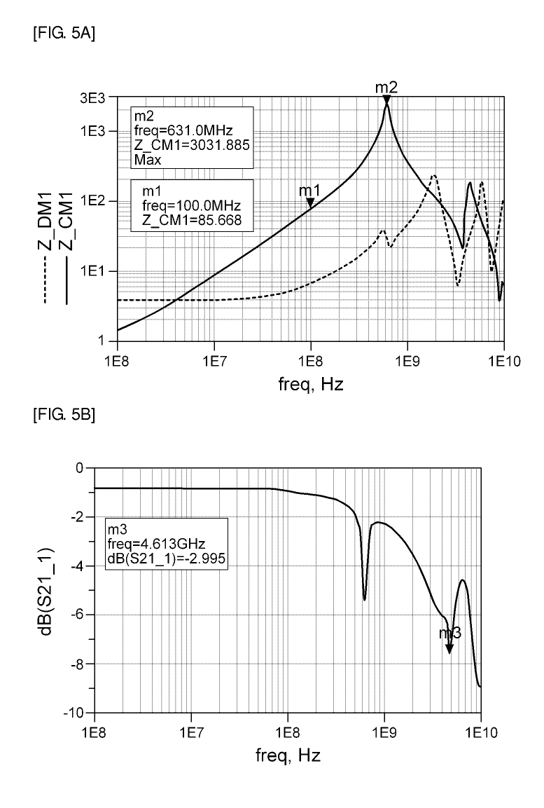

FIG. 1 is a perspective view of a common mode filter in accordance with the present invention, FIG. 2 is a cross-sectional view taken along line I-I′ of FIG. 1, FIGS. 3A-3L are a process flowchart sequentially showing a method of manufacturing a common mode filter in accordance with the present invention, and FIGS. 4A-4B and 5A-5B are graphs showing common mode impedance, SRF, and cutoff frequency characteristics according to the height of a second insulating layer. Additionally, the elements in the drawing figures are not necessarily drawn to scale. For example, the dimensions of some of the elements in the figures may be exaggerated relative to other elements to help improve understanding of embodiments of the present invention. Meanwhile, the same components are represented by the same reference numerals hereinafter throughout the specification. For simplicity and clarity of illustration, the drawing figures illustrate the general manner of construction, and descriptions and details of well-known features and techniques may be omitted to avoid unnecessarily obscuring the discussion of the described embodiments of the invention.

Referring to FIG. 1, a common mode filter 100 in accordance with the present invention may include a magnetic substrate 110 formed of a magnetic ceramic material, a first coil pattern 150 and a second coil pattern 151 sequentially formed on the magnetic substrate 110, an external electrode 160 laminated on the second coil pattern 151, a via 170 for connecting the first coil pattern 150 and the second coil pattern 151, and a second insulating layer formed between the first coil pattern 150 and the second coil pattern 151, wherein the height of the second insulating layer is 5 μm to 20 μm while being proportional to the height of the via.

The magnetic substrate 110 may be a base for manufacture of the thin film type common mode filter 100. The magnetic substrate 110 may be formed of a magnetic ceramic material.

The coil pattern may have a multilayer structure. For example, the coil pattern, which forms an electromagnetic coupling as an electrode plated on the plane in the form of a coil, may form one double-layer coil consisting of the first coil pattern 150 and the second coil pattern 151.

A magnetic layer 190 may be formed by filling a predetermined filler on the second insulating layer to improve permeability and impedance characteristics of the thin film type common mode filter 100. At this time, the filler may be a resin composition containing magnetic particles.

The magnetic substrate 110 and the magnetic layer 190 are spaces through which a magnetic flux passes and may be formed of Ni—Zn, Mn—Zn, Ni—Zn, Ni—Zn—Mg, and Mn—Mg—Zn ferrite or mixtures thereof having high electrical resistance and low magnetic loss to smooth the flow of magnetic flux.

As shown in FIG. 2, the coil patterns may be laminated to be vertically separated from each other by a predetermined interval with the insulating layer interposed therebetween.

The coil pattern may be formed on a ferrite sheet in consideration of a pattern shape or the number of turns or formed by etching the remaining portion of plating on the insulating layer except the portion in which a pattern is to be formed to leave only the coil pattern.

Further, since the insulating layer is a space through which a magnetic flux passes like the magnetic substrate 110 and the magnetic layer 190, common mode impedance can be improved by preventing a magnetic flux from leaking to the side surface while maintaining a vertical flux flow based on the inner center of the thin film type common mode filter 100.

The insulating layer may consist of a first insulating layer 141 under the first coil pattern 150, a second insulating layer 142 between the first coil pattern 150 and the second coil pattern 151, and a third insulating layer 143 on the second coil pattern 151.

The second insulating layer 142 should prevent a short between the first coil pattern 150 and the second coil pattern 151 and cracks of an interface layer due to incomplete bonding between the insulating layer and the coil pattern.

Since the second insulating layer 142 is not formed through the step of processing the via 170 while laminating the second coil pattern 151 thereon and the process of forming the via 170 on the innermost pattern after forming the first coil pattern 150 is performed first, the height of the second insulating layer 142 may be proportional to the height of the via 170.

That is, since the height of the second insulating layer 142 may be a maximum value of the height of the via 170 and the height of the insulating layer may be adjusted according to the purpose of design, it is possible to improve performance of the common mode filter 100 by reducing or minimizing the magnetic flux leaking to the side surface.

Since the second insulating layer 142 is laminated to the maximum height of the via 170 after forming the via 170, it is possible to prevent degradation of the via 170 and collapse of the peripheral PR pattern compared to the method of laminating the second coil pattern 151 after laminating the second insulating layer 142.

That is, in the common mode filter 100 in accordance with the present invention, self resonance frequency (SRF) and insertion loss characteristics can be improved and a bumpy surface and doming of the insulating layer due to polymer shrinkage can be reduced according to an increase in the height of the second insulating layer 142.

FIGS. 4A-4B and 5A-5B are simulation graphs that compare common mode impedance, SRF performance, and cutoff frequency performance of the common mode filter 100 in which the height of the second insulating layer 142 is set to 5 μm and the common mode filter 100 in which the height of the second insulating layer 142 is set to 15 μm.

The common mode filter in accordance with an embodiment of the present invention has a disadvantage that the common mode impedance is somewhat reduced, but it can be checked that the SRF is improved by 38.7% from 455 MHz to 631 MHz and the cutoff frequency is improved by 76.2% from 2.618 GHz to 4.613 GHz.

The common mode impedance (Ω), SRF, and cutoff frequency according to the height of the second insulating layer 142 are as in Table 1.

TABLE 1

| Height of second | Common mode | | Cutoff frequency |
|---|---|---|---|
| insulating layer (μm) | impedance (Ω) | SRF (MHz) | (GHz) |
| 5 | 102.4 | 455.0 | 2.618 |
| 6 | 100.3 | 478.9 | 2.857 |
| 7 | 98.6 | 496.5 | 3.056 |
| 8 | 96.9 | 514.1 | 3.256 |
| 9 | 95.3 | 531.7 | 3.455 |
| 10 | 92.7 | 562.0 | 3.733 |
| 11 | 91.9 | 566.9 | 3.854 |
| 12 | 90.2 | 584.5 | 4.054 |
| 13 | 88.5 | 602.1 | 4.253 |
| 14 | 86.9 | 619.7 | 4.453 |
| 15 | 85.6 | 631.0 | 4.613 |
| 16 | 83.5 | 654.9 | 4.852 |
| 17 | 81.8 | 672.5 | 5.051 |
| 18 | 80.1 | 690.1 | 5.251 |
| 19 | 78.5 | 707.7 | 5.450 |
| 20 | 76.8 | 725.3 | 5.650 |
| 21 | 75.1 | 742.9 | 5.849 |
| 22 | 73.4 | 760.5 | 6.049 |
| 23 | 71.7 | 778.1 | 6.248 |
| 24 | 70.1 | 795.7 | 6.448 |
| 25 | 68.4 | 813.3 | 6.647 |
| 30 | 60.0 | 901.3 | 7.645 |

As shown in Table 1, in the common mode filter 100 according to the present invention, characteristic values such as common mode impedance, SRF, and cutoff frequency can be changed according to the height of the second insulating layer 142.

The common mode impedance should be selected within the range that satisfies impedance matching, and the higher the SRF and cutoff frequency characteristics, the characteristics at high frequencies can be improved.

When the height of the second insulating layer 142 is increased, while the common mode impedance value is reduced due to a reduction in effect of interference between signals, the SRF and the cutoff frequency are increased due to a reduction in capacitance caused by parasitic capacitance generated between the insulating layers.

Meanwhile, when the height of the second insulating layer 142 is less than 5 μm, a failure rate may be increased by a high possibility of electrical short due to unbalanced coverage of the insulating layer and reliability degradation such as cracks of the second insulating layer 142 may be caused.

Further, when the height of the second insulating layer 142 exceeds 20 μm, the common mode impedance may be remarkably reduced than a design value due to a process failure such as voids or filling of only a resin except ferrite powder in the process of filling the ferrite resin using screen printing, thus causing mass-production of products unsuitable as a common mode filter.

Therefore, it may be appropriate that the height of the second insulating layer 142 is set to 5 μm to 20 μm. At this time, it may be optimal that the second insulating layer 142 having a height of 7 μm to 18 μm is selected to overcome a reliability threshold in 5 μm to 20 μm since the second insulating layer 142 has a fine height.

FIGS. 3A-3L is a process flowchart showing a method of manufacturing a common mode filter 100 in accordance with the present invention.

The steps of applying a first PR 131 on a magnetic substrate 110 having a first seed layer 121 thereon, forming a first coil pattern 150 by performing electroplating using the first seed layer 121 as a lead line after selectively etching the first PR 131, applying a second PR 132 on the first PR 131 and etching the second PR 132 to form a first opening 137 in the first coil pattern 150, forming a via 170 by filling a conductive paste in the first opening 137, forming a first cavity 135 by stripping the first PR 131 and the second PR 132, forming a second insulating layer 142 by filling an insulating material in the first cavity 135, forming a second coil pattern 151 on the second insulating layer 142, and forming an external electrode 160 on the second coil pattern 151 may be included.

The photoresist (PR) is a photosensitive polymer that performs photo exposure when receiving light of a specific wavelength. When a portion of the PR is exposed, polymer chains in the exposed portion are cut or more strongly bonded, and in order to form PR patterning, a positive PR that cuts polymer chains is used.

And a developing process for dissolving the PR in the portion having relatively weak bonding by the exposure process using a solvent is performed. The polymer chains unchained by photosensitization are dissolved to be selectively etched, and a plating process is performed on the etched portion to form a coil pattern.

When the first PR 131 is etched, the first seed layer 121, which is a seed of electroplating, is exposed, and when the plating is performed, the first coil pattern 150 is formed. It is preferred that the height of the first coil pattern 150 is formed to the height of the first PR 13.

The prior art is performed in the order of forming the first coil pattern 150, laminating the insulating layer, and forming the second coil pattern 151, but the present invention applies the second PR 132 on the first PR 131 and the first coil pattern 150 without removing the first PR 131 after forming the first coil pattern 150 and etches the second PR 132 only in the portion where the via 170 is to be formed.

The via 170 is formed by filling a conductive paste in the etched portion of the second PR 132. The height of the via 170 may be the same as the height of the second PR 132. When the via 170 is formed, the first cavity 135 is formed by removing the first PR 131 and the second PR 132.

Further, the etched portion of the second PR 132 may include a portion in which a bump electrode 180 is formed by being filled with a conductive paste to connect the coil pattern and the external electrode. A plurality of external electrodes may be connected to ends of the first coil pattern and the second coil pattern one to one through the bump electrode 180.

Meanwhile, when the first cavity 135 is formed, a flash etching step of removing the first seed layer 121 exposed under the first coil pattern 150 may be further included. Since the adjacent first coil patterns 150 can function as an inductor when electrically open, the exposed first seed layer 121 should be removed to prevent an electrical short between the adjacent first coil patterns 150 due to the first seed layer 121.

The first cavity 135 includes a region in which the insulating layer is to be filled except the via 170 in which the first coil pattern and the second insulating layer 142 are to be formed and prevents a short by separating the adjacent first coil patterns 150 when the insulating material is filled. The second insulating layer 142 is formed on the first coil pattern 150 to electrically and physically separate the first coil pattern 150 and the second coil pattern 151.

Since the method of manufacturing a common mode filter 100 in accordance with an embodiment of the present invention plates the via portion and the electrode portion first, it is possible to manufacture a common mode filter 100 with improved SRF and insertion loss characteristics by changing the height of the via 170 to change the height of the insulating layer corresponding to the height of the via 170.

Further, the present invention doesn't have an obstacle to a photolithography process by preventing formation of an uneven bumpy surface when spin coating a liquid type polymer insulator.

And it is possible to prevent doming of the insulator due to polymer shrinkage when curing the polymer insulator and delamination due to cracks caused by a wet process or penetration of external moisture.

After the step of forming the second insulating layer 142, the process of forming the second coil pattern 151 is performed. The second coil pattern 151 may be formed by performing screen printing on a ferrite sheet or etching a plating layer laminated on the ferrite sheet.

Meanwhile, the second coil pattern 151 may be formed by the same process as the first coil pattern 150.

The second coil pattern 151 is formed by applying a third PR 133 on the second insulating layer 142 having a second seed layer 122 thereon, selectively etching the third PR 133, and performing electroplating using the second seed layer 122 as a lead line.

And a fourth PR 134 is applied on the second coil pattern 151 and the third PR 133 and etched to form a second opening 138 in the second coil pattern 151.

The second opening 138, which forms the bump electrode 180 to connect the coil pattern and the external electrode 160, not the via 170 for connecting the upper and lower coil patterns like the first opening 137, may be formed by filling a conductive paste.

When the bump electrode 180 is formed, the third PR 133 and the fourth PR 134 are stripped to form a second cavity 136, and the adjacent coil patterns 151 are electrically and physically open by removing the second seed layer 122 exposed between the second coil patterns 151 through a flash etching process.

Since the external electrodes 160 should be connected to the ends of the coil patterns, they are formed to correspond to the bump electrodes 180 to be connected to each other. The external electrodes 160 may be provided in plural number to be connected to the respective ends of the coil patterns one to one. Therefore, the external electrodes 160 can be connected to the respective ends of the first coil pattern 150 and the second coil pattern 151 to be conducted.

When the external electrode 160 is formed, a magnetic layer 190 is filled around the external electrode 160. The magnetic layer 190 may be formed by filling a predetermined filler on a third insulating layer 143 to improve permeability and impedance characteristics of the thin film type common mode filter 100.

The magnetic layer 190 should be filled to the height corresponding to the height reaching the uppermost end of the external electrode 160 from the top of the third insulating layer 143 and satisfy filler selection standards to prevent depression or cracks of the center portion of the common mode filter 100.

As described above, the common mode filter and the method of manufacturing the same in accordance with the present invention can increase the height of the insulating layer by forming the via connected to the upper and lower coil patterns before the insulating layer.

Further, the present invention can improve SRF and insertion loss characteristics by securing the height of the insulating layer and improve quality by reducing the bumpy surface and the doming of the insulating layer issued in the conventional invention.

The foregoing description illustrates the present invention. Additionally, the foregoing description shows and explains only the preferred embodiments of the present invention, but it is to be understood that the present invention is capable of use in various other combinations, modifications, and environments and is capable of changes and modifications within the scope of the inventive concept as expressed herein, commensurate with the above teachings and/or the skill or knowledge of the related art. The embodiments described hereinabove are further intended to explain best modes known of practicing the invention and to enable others skilled in the art to utilize the invention in such, or other, embodiments and with the various modifications required by the particular applications or uses of the invention. Accordingly, the description is not intended to limit the invention to the form disclosed herein. Also, it is intended that the appended claims be construed to include alternative embodiments.

1. A common mode filter comprising:
a magnetic substrate formed of a magnetic ceramic material;
a first coil pattern and a second coil pattern sequentially formed on the magnetic substrate;
an external electrode laminated on the second coil pattern;
a via for connecting the first coil pattern and the second coil pattern; and
a second insulating layer formed between the first coil pattern and the second coil pattern, wherein the height of the second insulating layer is 5 μm to 20 μm while being proportional to the height of the via.

2. The common mode filter according to claim 1, wherein the external electrodes are provided in a plural number to be connected to respective ends of the first coil pattern and the second coil pattern one to one.

3. A method of manufacturing a common mode filter, comprising:
applying a first PR on a magnetic substrate having a first seed layer thereon;
forming a first coil pattern by performing electroplating using the first seed layer as a lead line after selectively etching the first PR;
applying a second PR on the first PR and etching the second PR to form a first opening in the first coil pattern;
forming a via by filling a conductive paste in the first opening;
forming a first cavity by stripping the first PR and the second PR;
forming a second insulating layer by filling an insulating material in the first cavity;
forming a second coil pattern on the second insulating layer; and
forming an external electrode on the second coil pattern.

4. The method of manufacturing a common mode filter according to claim 3, wherein forming the external electrode further comprises processing a via for mutually connecting a plurality of external electrodes corresponding to the first coil pattern and the second coil pattern one to one.

5. A method of manufacturing a common mode filter, comprising:
applying a first PR on a substrate having a first seed layer thereon;
forming a first coil pattern by performing electroplating using the first seed layer as a lead line after selectively etching the first PR;
applying a second PR on the first PR and etching the second PR to form a first opening in the first coil pattern;
forming a via by filling a conductive paste in the first opening;
forming a first cavity by stripping the first PR and the second PR;
applying a third PR on a second insulating layer;
forming a second coil pattern by performing electroplating using a second seed layer as a lead line after selectively etching the third PR;
applying a fourth PR on the third PR and etching the fourth PR to form a second opening in the second coil pattern;
forming a bump electrode by filling a conductive paste in the second opening; and
forming a second cavity by stripping the third PR and the fourth PR.

6. The method of manufacturing a common mode filter according to claim 3, further comprising, before applying the first PR, laminating a first insulating layer.

7. The method of manufacturing a common mode filter according to claim 3, wherein when applying the second PR, the height of the second PR is 5 to 20 μm.

8. The method of manufacturing a common mode filter according to claim 3, wherein the first opening is formed in the innermost first coil pattern.

9. The method of manufacturing a common mode filter according to claim 3, wherein forming the first cavity by stripping the first PR and the second PR further comprises forming a first electrode coil by further including a flash etching process.

10. The method of manufacturing a common mode filter according to claim 3, wherein the second insulating layer is formed by applying an insulating material after forming the first cavity.

11. The method of manufacturing a common mode filter according to claim 5, wherein a third insulating layer is formed by applying an insulating material after forming the second cavity.

12. The method of manufacturing a common mode filter according to claim 5, wherein the second opening is formed on a second electrode coil.

13. The method of manufacturing a common mode filter according to claim 5, wherein forming the second cavity by stripping the third PR and the fourth PR further comprises forming the second electrode coil by further including a flash etching process.

14. The method of manufacturing a common mode filter according to claim 5, further comprising, before applying the first PR, laminating a first insulating layer.

15. The method of manufacturing a common mode filter according to claim 5, wherein when applying the second PR, the height of the second PR is 5 to 20 μm.

16. The method of manufacturing a common mode filter according to claim 5, wherein the first opening is formed in the innermost first coil pattern.

17. The method of manufacturing a common mode filter according to claim 5, wherein forming the first cavity by stripping the first PR and the second PR further comprises forming a first electrode coil by further including a flash etching process.

18. The method of manufacturing a common mode filter according to claim 5, wherein the second insulating layer is formed by applying an insulating material after forming the first cavity.
